(19) United States
(12) Patent Application Publication
(10) Pub. No.: US 2020/0327460 A1
(43) Pub. Date: Oct. 15, 2020

(54) INFORMATION PROCESSING APPARATUS, INFORMATION PROCESSING METHOD AND PROGRAM

(71) Applicant: TOYOTA JIDOSHA KABUSHIKI KAISHA, Toyota-shi (JP)

(72) Inventors: Koichi SUZUKi, Miyoshi-shi (JP); Toru NISHITANI, Nisshin-shi (JP); Jun USAMI, Toyota-shi (JP); Minami YODA, Tokyo (JP); Kensuke KOIKE, Nisshin-shi (JP); Tsuyoshi OGAWA, Okazaki-shi (JP); Yohei TANIGAWA, Toyota-shi (JP)

(73) Assignee: TOYOTA JIDOSHA KABUSHIKI KAISHA, Toyota-shi (JP)

(21) Appl. No.: 16/844,273

(22) Filed: Apr. 9, 2020

(30) Foreign Application Priority Data
Apr. 12, 2019 (JP) 2019-076439

(51) Int. Cl. G06Q 10/02; G06Q 10/08; H04W 4/021; H04W 4/029; G06Q 50/30

(52) U.S. Cl. CPC G06Q 10/02; G06Q 10/08355; G06Q 50/30; H04W 4/021; H04W 4/029; G06Q 10/0832

(57) ABSTRACT

A control unit of a server device, as an information processing apparatus of the present disclosure, is configured to execute: notifying a terminal held by a first user associated with pick-up/delivery (P/D) of a package of a P/D route and a scheduled passing time of the P/D route, at a predetermined time before a scheduled P/D time; receiving a boarding request of the first user, which is for boarding at a first location on the P/D route or within a first predetermined range around the P/D route, from the terminal; and transmitting to a moving object traveling for the P/D, a command for transporting the first user from the first location to a P/D destination.

### CROSS-REFERENCE TO RELATED APPLICATION

This application claims priority to Japanese Patent Application No. 2019-076439 filed on Apr. 12, 2019, incorporated herein by reference in its entirety.

### BACKGROUND

### 1. Technical Field

The present disclosure relates to an information processing apparatus, an information processing method executed by the information processing apparatus, and a program.

### 2. Description of Related Art

Delivery services for delivering packages to, for example, homes have been widely provided. For enhancing the efficiency of the delivery service, it has been proposed to use, for example, a delivery box (see, for example, JP-B-6164599).

### SUMMARY

In the related art, shortcomings related to providing a delivery service are recognized, including, but not limited to, inefficiency due to cases where the recipient is absent at the time of delivery, and a labor shortage in terms of an increase in the number of packages to be delivered. However, convenience of the customer who uses the delivery service or a third party other than the customer is rarely and insufficiently considered. Therefore, the present disclosure is intended to enhance the convenience of the customer of the service and a third party in terms of the pick-up/delivery (P/D) service including the delivery of packages.

One aspect of the present disclosure is implemented by an information processing apparatus including a control unit. The control unit is configured to execute: notifying a terminal held by a first user associated with package pick-up/delivery (P/D) of a package of a P/D route and a scheduled passing time of the P/D route, at a predetermined time before a scheduled P/D time; receiving a boarding request of the first user, which is for boarding at a first location on the P/D route or within a first predetermined range around the P/D route, from the terminal; and transmitting to a moving object traveling for the P/D, a command for transporting the first user from the first location to a P/D destination. Another aspect of the present disclosure is also implemented by an information processing method executed by at least one computer such as the information processing apparatus. Yet another aspect of the present disclosure is also implemented by a program for causing at least one computer, such as the information processing apparatus, to execute the information processing method.

According to the information processing apparatus of the present disclosure, it is possible to enhance the convenience of the user in relation to the package P/D service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram of an operation of a system according to a first embodiment of the present disclosure;

FIG. 2 is a block diagram schematically illustrating a configuration of the system of FIG. 1, particularly illustrating a configuration of an autonomous vehicle;

FIG. 3 is a block diagram schematically illustrating a configuration of the system of FIG. 1, particularly illustrating a configuration of a server device;

FIG. 4 is a block diagram schematically illustrating a configuration of the system of FIG. 1, particularly illustrating a configuration of a user device;

FIG. 5 is a diagram illustrating a display example of a display unit of the user device shown in FIG. 4;

FIG. 6 is a flowchart of a processing of the server device in the system of FIG. 1;

FIG. 7 is a diagram illustrating a display example of the display unit of the user device shown in FIG. 4, at a timing different from that of FIG. 5;

FIG. 8 is a flowchart of a processing of the autonomous vehicle in the system of FIG. 1;

FIG. 9 is a block diagram schematically illustrating a configuration of a system according to a second embodiment of the present disclosure, particularly illustrating a configuration of a server device;

FIG. 10 is a conceptual diagram of an operation of the system according to the second embodiment of the present disclosure;

FIG. 11 is a flowchart of a processing in a specific function module of a server device in the system according to the second embodiment; and

FIG. 12 is a flowchart of a processing in another specific function module of the server device in the system according to the second embodiment.

### DETAILED DESCRIPTION OF EMBODIMENTS

Hereinafter, an information processing apparatus according to an embodiment of the present disclosure, an information processing method in the information processing apparatus, and a program will be described referring to drawings. A first embodiment will be described hereinbelow.

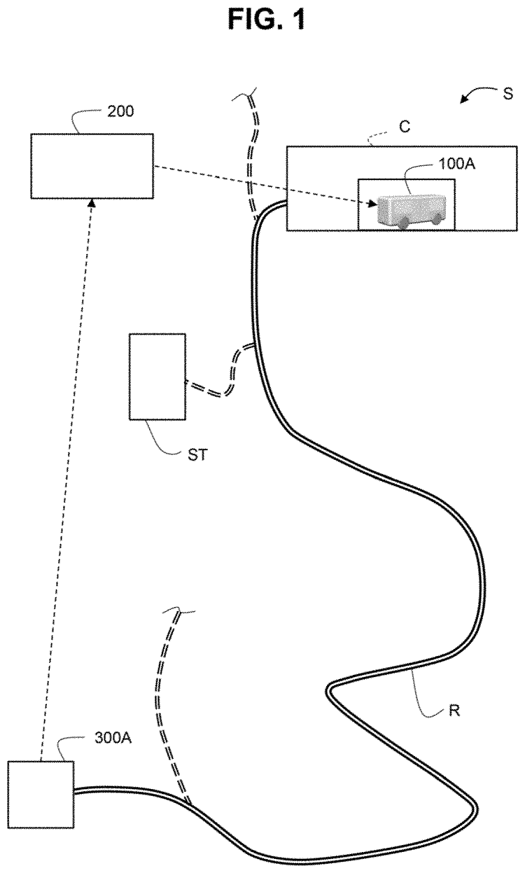

FIG. 1 conceptually shows a pick-up/delivery (P/D) system S according to the first embodiment of the present disclosure. The P/D system S includes an autonomous vehicle 100 and a server device 200. The autonomous vehicle 100 is one example of a moving vehicle for package P/D. The server device 200 is an information processing apparatus and is a computer on a network N. The server device 200 is configured to communicate with each of the autonomous vehicles 100 via the network N, and cooperates with the information processing apparatus of the autonomous vehicle 100 via the network N. Although FIG. 1 illustrates only the autonomous vehicle 100A, among a plurality of autonomous vehicles 100 (100A, 100B, 100C, . . . ), the number of autonomous vehicles 100 is not limited and may be any number.

FIG. 1 illustrates a state in which the autonomous vehicle 100A is waiting at a P/D center C. Each of the autonomous vehicles 100 can travel to a P/D destination in order to pick up or deliver packages. In the P/D system S, when the packages are picked up or delivered, the autonomous vehicle 100, which is a moving vehicle for P/D, travels towards a pick-up destination to receive the packages, and collects the received packages at the P/D center C nearest to the pick-up destination. The same or different autonomous vehicle 100 carries the packages from the P/D center to another P/D center nearest to a delivery destination. Further, the same or different autonomous vehicle 100 carries the packages from another P/D center C to the delivery destination. Moreover, the P/D destinations include the pick-up destination and the delivery destination.

The server device 200 is provided outside the P/D center C. The server device 200 may be provided at the P/D center C, but herein, is provided outside the P/D center C. The server device 200 can communicate with other server devices, and the li via the network N. The server device 200 is configured to communicate with each of the autonomous vehicles 100 via the network N, and also to communicate with a user device 300 via the network N.

The user device 300 is configured to communicate with the server device 200 via the network N. Although FIG. 1 illustrates only the user device 300A, out of several user devices 300 (300A, 300B, 300C, . . . ), the number of user devices is not limited and may be any number.

The autonomous vehicle 100 is also called an Electric Vehicle (EV) pallet. The autonomous vehicle 100 is a moving vehicle having various sizes and is capable of automatic driving and unmanned driving. For example, autonomous vehicles 100 of various sizes are available, e.g. from small vehicles that can only load a small amount of packages and only one person can board, to large vehicles. Particularly, in the present embodiment, the autonomous vehicle 100 is a vehicle that can load both passengers and luggage, and thus is capable of transporting people as well as packages.

The autonomous vehicle 100 has a control function for controlling itself, and a communication function. The autonomous vehicle 100 can provide, to a user, functions and services added by the server device on the network by cooperating with the server device on the network, in addition to processing that can be executed by the autonomous vehicle 100 alone. In addition, the autonomous vehicle 100 does not have to be an unmanned vehicle. For example, sales staff, service staff or security staff may board in the vehicle. Further, the autonomous vehicle 100 may not necessarily be a vehicle capable of complete autonomous traveling. For example, it may be a vehicle in which a person drives or assists driving, depending on a situation.

Further, the autonomous vehicle 100 is configured to communicate with the user device 300 (300A, . . . ) via the network N. The user device 300 accepts an input from a user and an operation equivalent to such an input, and can communicate not only with the server device 200 but also with the autonomous vehicle 100 via the network N. The user device 300 and the autonomous vehicle 100 may directly transmit and receive information, to and from each other.

The server device 200 is a device that issues the operation command to the autonomous vehicle 100. For example, the server device 200 may transmit to the autonomous vehicle 100 a service command for P/D, including, for example, information on the packages to be delivered to or collected from the P/D destination at a specific time.

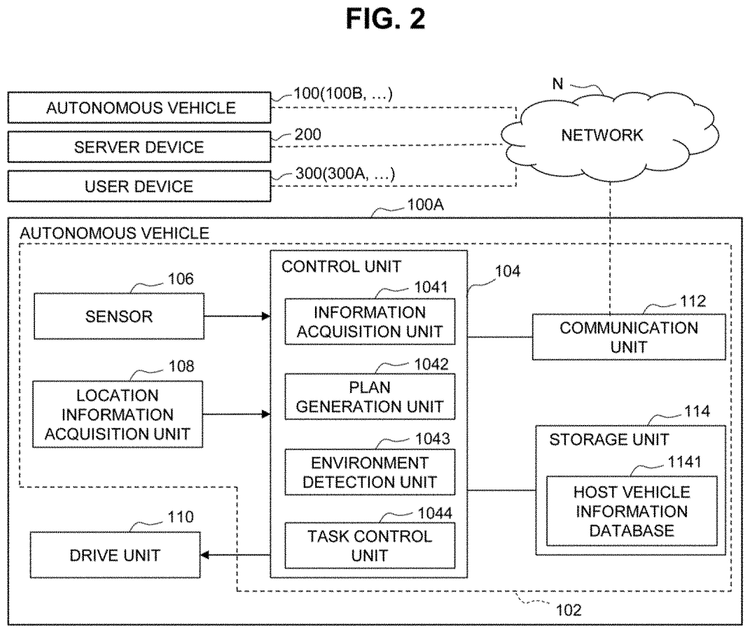

Each component in the P/D system S of FIG. 1 will be described in detail hereinbelow. FIG. 2 is a block diagram schematically illustrating a configuration of the P/D system S including the autonomous vehicle 100, the server device 200, and the user device 300; in particular, a diagram showing a configuration of the autonomous vehicle 100A. In FIG. 2, a configuration of the autonomous vehicle 100A is shown as one example of the autonomous vehicle 100. Other autonomous vehicles 100B, 100C and the like have the same configuration as that of the autonomous vehicle 100A.

The autonomous vehicle 100A in FIG. 2 is provided with an information processing apparatus 102, and includes a control unit 104 that substantially performs functions thereof. The autonomous vehicle 100A can travel based on the service command acquired from the server device 200. In particular, the autonomous vehicle 100A travels in an appropriate manner based on the service command acquired via the network N while detecting the surroundings of the vehicle. The autonomous vehicle 100A executes processing related to package P/D and the boarding/alighting of various users while traveling, based on the service command.

The autonomous vehicle 100A further includes a sensor 106, a location information acquisition unit 108, a drive unit 110, a communication unit 112, and a storage unit 114. The autonomous vehicle 100A operates with electric power supplied from a battery.

The sensor 106 senses the surroundings of the vehicle, which typically includes a stereo camera, a laser scanner, LIDAR (light detection and ranging, or laser imaging detection and ranging), radar, and the like. The information acquired by the sensor 106 is transmitted to the control unit 104. The sensor 106 includes a sensor that enables a host vehicle to perform autonomous travel. The sensor 106 may also include a camera provided on a body of the autonomous vehicle 100A. For example, the sensor 106 can include an image capturing device using an image sensor such as charged-coupled devices (CCD), a metal-oxide-semiconductor (MOS) or a complementary metal-oxide-semiconductor (CMOS). A plurality of cameras may be provided at a plurality of points on a vehicle body. For example, cameras may be installed on the front, rear, and left and right sides of the vehicle body, respectively.

The location information acquisition unit 108 is a unit that obtains a current location of the vehicle, which typically includes a global positioning system (GPS). The information acquired by the location information acquisition unit 108 is transmitted to the control unit 104. A GPS receiver, as a satellite signal receiver, receives signals from a plurality of GPS satellites. Each GPS satellite is an artificial satellite that orbits the earth. A satellite positioning system, i.e. navigation satellite system (NSS), is not limited to a GPS. The location information may be detected based on signals from various satellite positioning systems. NSS is not limited to a global navigation satellite system, but may include a Quasi-Zenith Satellite System, such as “Galileo” in Europe, and “Michibiki” in Japan which is integrated with GPS.

The control unit 104 is a computer that controls the autonomous vehicle 100A based on information acquired from the sensor 106, the location information acquisition unit 108 and the like. The control unit 104 is one example of a control unit that receives the service command from the server device 200 and controls traveling of the autonomous vehicle 100A (moving vehicle), package P/D, and the boarding/alighting of various users.

The control unit 104 includes a CPU and a main storage unit, and executes information processing by a program. The CPU is also called a processor. The main storage unit of the control unit 104 is one example of a main storage device. The CPU in the control unit 104 executes a computer program that is deployed so as to be executable manner in the main storage unit, and provides various functions. The main storage unit in the control unit 104 stores computer programs executed by the CPU, data, and the like. The main storage unit in the control unit 104 is a dynamic random access memory (DRAM), a static random access memory (SRAM), a read only memory (ROM), or the like.

The control unit 104 is connected to the storage unit 114. The storage unit 114 is a so-called external storage unit, which is used as a storage area that assists the main storage unit of the control unit 104, and stores computer programs, data and the like, executed by the CPU of the control unit 104. The storage unit 114 may be a hard disk drive, a solid state drive (SSD), or the like.

The control unit 104 includes an information acquisition unit 1041, a plan generation unit 1042, an environment detection unit 1043, and a task control unit 1044 as functional modules. Each functional module is implemented by executing a program stored in the main storage unit or the storage unit 114 by the control unit 104, that is, the CPU.

The information acquisition unit 1041 acquires information on the service command from the server device 200. The service command includes P/D information and boarding information associated therewith. The P/D information may include information on dimensions of the packages related to P/D, P/D destination, scheduled time of package P/D, P/D route, and/or scheduled passing time of the P/D route. The boarding information may include user information (for example, user ID), and information on locations where the user boards and/or alights the vehicle. The information acquisition unit 1041 acquires, regularly or irregularly, information on a host vehicle, for example information on the packages to be loaded, and stores such information in a host vehicle information database 1141 of the storage unit 114.

The service plan generation unit 1042 generates a service plan of the host vehicle based on the information on the service command acquired from the server device 200. Moreover, the service plan generated by the service plan generation unit 1042 is transmitted to the task control unit 1044 described later. In the present embodiment, the service plan is data defining a route on which the autonomous vehicle 100A travels and processing to be performed by the autonomous vehicle 100A on a part or all of the route. Examples of the data contained in the service plan include the following.

(1) Data Representing the Route on which the Host Vehicle Travels with a Set of Road Links

The route on which the host vehicle travels may be automatically generated based on a given departure point and destination, on the basis of the P/D route information included in the service command, with reference to map data stored in the storage unit 114, for example. Alternatively, the route may be generated using an external service.

(2) Data Representing the Process that the Host Vehicle should Perform at a Point on the Route

The processing performed by the host vehicle on the route may be, for example, but not limited to, “receiving the package”, “delivery of the package”, “user boarding”, “user alighting” and “receiving a receipt”.

The environment detection unit 1043 detects the environment around the vehicle based on the data acquired by the sensor 106. Detection targets may include, for example, but are not limited to, the number and positions of lanes, the number and positions of vehicles around the host vehicle, the number and positions of obstacles (for example, pedestrians, bicycles, structures, buildings, and the like) around the host vehicle, road structures, road signs, and the like. Any detection target may be used as long as it is necessary for autonomous traveling. Further, the environment detection unit 1043 may track the detected object. For example, the relative velocity of the object may be obtained from a difference between the object's previous coordinates detected one step before and the object's current coordinates. Data relating to the environment (hereinafter referred to as “environment data”) detected by the environment detection unit 1043 is transmitted to the task control unit 1044.

The task control unit 1044 controls operation (traveling) of the host vehicle, which is the moving vehicle, based on the service plan generated by the plan generation unit 1042, the environment data generated by the environment detection unit 1043, and the location information of the host vehicle acquired by the location information acquisition unit 108. For example, the host vehicle may be directed to travel along a predetermined route such that an obstacle does not enter a predetermined safety area centered on the host vehicle. A well-known method can be adopted as a method for allowing the vehicle to autonomously travel. The traveling of the autonomous vehicle 100A is controlled based on the P/D information. The task control unit 1044 also executes tasks other than traveling based on the service plan generated by the plan generation unit 1042. Examples of the task include the boarding and alighting of the user, issuing a receipt, and the like.

The drive unit 110 is a unit configured to allow the autonomous vehicle 100A to travel based on a command generated by the task control unit 1044. The drive unit 110 may include, for example, a motor for driving wheels, an inverter, a brake, a steering mechanism, a secondary battery, and the like.

The communication unit 112 has a communication tool configured to allow the autonomous vehicle 100A to access the network N. In the present embodiment, the autonomous vehicle 100A can communicate with other devices (for example, the server device 200 or the user device 300) via the network N. Further, the communication unit 112 may further include a communication unit for inter-vehicle communication between the autonomous vehicle 100A (host vehicle) and other autonomous vehicles 100 (100B, . . . ).

Next, the server device 200 will be described. The server device 200 acquires a package P/D request from the user device 300 (300A, . . . ) and, based on the request, generates and transmits a service command for the autonomous vehicle 100 (100A, . . . ). Further, the server device 200 acquires a boarding request from the user device 300 and, based on the request, generates and transmits a service command for the autonomous vehicle 100.

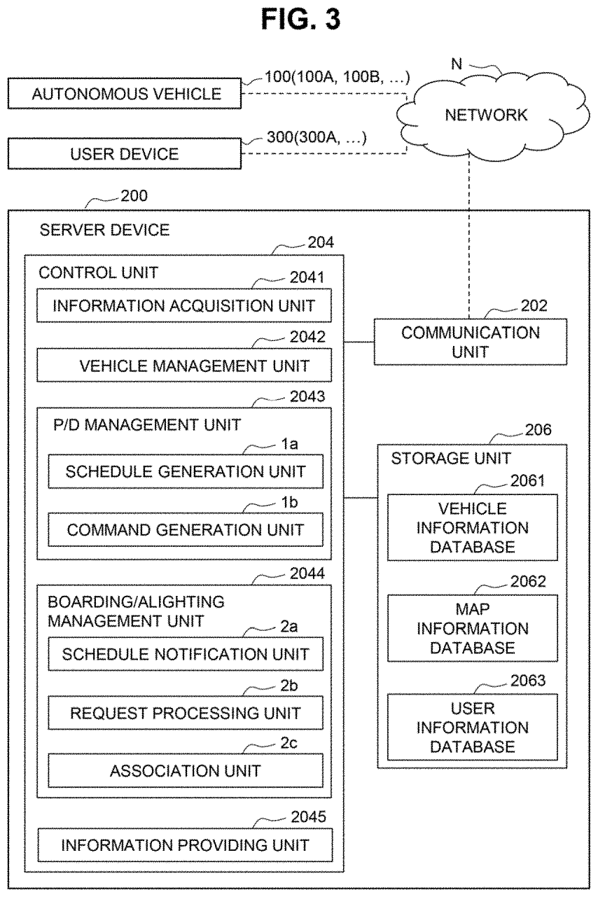

The server device 200 is the information processing apparatus, and includes a communication unit 202, a control unit 204, and a storage unit 206, as shown in FIG. 3. The communication unit 202 is the same as the communication unit 112 and has a communication function for connecting the server device 200 to the network N. The communication unit 202 of the server device 200 is a communication interface for communicating with the autonomous vehicle 100 and the user device 300 via the network N. The control unit 204 includes a CPU and a main storage unit, and executes information processing by a program, similar to the control unit 104. This CPU is also a processor, and the main storage unit of the control unit 204 is also one example of a main storage device. The CPU in the control unit 204 executes a computer program that is deployed so as to be executable in the main storage unit, and provides various functions. The main storage unit in the control unit 204 stores computer programs executed by the CPU, data, and the like. The main storage unit in the control unit 204 may be a DRAM, SRAM, ROM, or the like.

The control unit 204 is connected to the storage unit 206. The storage unit 206 is an external storage unit, which is used as a storage area that assists the main storage unit of the control unit 204, and stores computer programs, data and the like, executed by the CPU of the control unit 204. The storage unit 206 may be a hard disk drive, an SSD, or the like.

The control unit 204 is a unit configured to control the server device 200. As illustrated in FIG. 3, the control unit 204 includes, as functional modules, an information acquisition unit 2041, a vehicle management unit 2042, a P/D management unit 2043, a boarding/alighting management unit 2044, and an information providing unit 2045. The P/D management unit 2043 has a schedule generation unit 1a and a command generation unit 1b. Further, the boarding/alighting management unit 2044 has a schedule notification unit 2a, a request processing unit 2b, and an association unit 2c. Each of these functional modules is implemented by executing a program stored in the main storage unit or the storage unit 206 by the CPU of the control unit 204.

The information acquisition unit 2041 acquires various information from the autonomous vehicle 100 and the user device 300, for example, the P/D request and the boarding request from the user device 300. The acquired information is transmitted to the P/D management unit 2043 and the boarding/alighting management unit 2044. Further, the information acquisition unit 2041 periodically acquires, from the autonomous vehicle 100, location information, information in the host vehicle information database 1141 and the like, and transmits such information to the vehicle management unit 2042.

The vehicle management unit 2042 manages information from the plurality of autonomous vehicles 100 that are under management. In particular, information such as data related to the autonomous vehicle 100 is received from the plurality of autonomous vehicles 100 via the information acquisition unit 2041 and is stored in a vehicle information database 2061 of the storage unit 206 at predetermined intervals. The location information and the vehicle information are used as information on the autonomous vehicle 100. Examples of the vehicle information include, but are not limited to, identifier, usage/type, information on a standby point (garage or sales office), door type, vehicle body size, luggage compartment size, loading capacity, travel distance remaining when fully charged, travel distance remaining at present, current status, and the like, of the autonomous vehicle 100.

The P/D management unit 2043 generates the service command including the P/D information described above, by generating a P/D schedule based on the information acquired by the information acquisition unit 2041. When the schedule is generated, P/D schedule information including a P/D route and a scheduled passing time of such a route is also generated. For generating the P/D route and the like, the schedule generation unit 1a refers to a map information database 2062 of the storage unit 206. Further, generating the schedule includes determining a suitable vehicle for package P/D. For example, a suitable vehicle may be determined based on the size of the package related to P/D, a location of the P/D destination, and P/D date and time. Upon this determination, the schedule generation unit 1a searches the vehicle information database 2061. In addition, the command generation unit 1b generates the service command including the P/D information and the boarding information, which are associated with each other by the boarding/alighting management unit 2044.

The boarding/alighting management unit 2044 notifies the user device 300 of the user (hereinafter, “first user”) related to P/D, of the schedule generated by the schedule generation unit 1a of the P/D management unit 2043, and associates the boarding request of the first user, if any, with the P/D schedule. The schedule notification unit 2a can use user information of a user information database 2063 of the storage unit 206, for example the associated user ID and user contact information, when notifying a terminal of the first user. The request processing unit 2b processes and accepts the first user's boarding request, by determining whether or not the first user's boarding request from the first user's user device 300 is acceptable, or by determining whether or not the boarding request conflicts with the P/D schedule. When the request processing unit 2b accepts the first user's boarding request, the association unit 2c transmits the boarding request to the command generation unit 1b of the P/D management unit 2043, and associates the boarding request with the P/D information. The boarding request includes information on locations where the first user wants to board and alight. Moreover, the first user is a user related to P/D.

The information providing unit 2045 provides the information on the service command generated by the command generation unit 1b of the P/D management unit 2043 to the autonomous vehicle 100 determined by the schedule generation unit 1a. The information on the service command includes the P/D information and the boarding information described above.

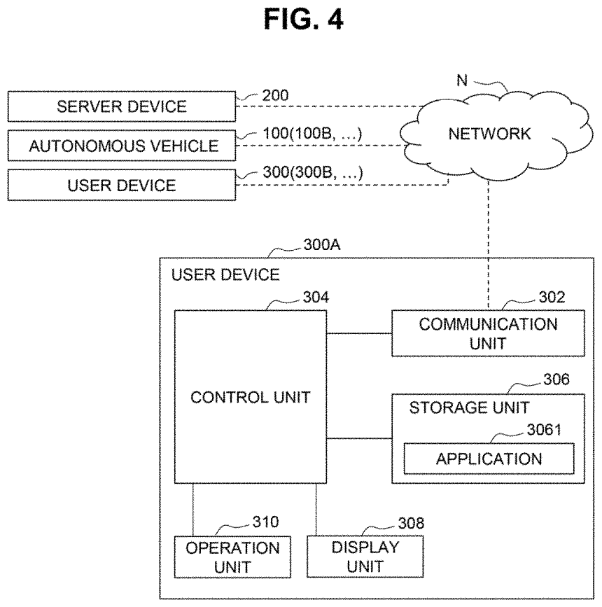

Next, the user device 300 will be described hereinbelow. The user device 300 may be, for example, a mobile terminal, a smartphone, a personal computer, or the like. The user device 300A shown in FIG. 4, as an example, has a communication unit 302, a control unit 304, and a storage unit 306. The communication unit 302 and the storage unit 306 of the user device 300A are the same as the communication unit 202 and the storage unit 206 of the server device 200, respectively. Furthermore, the user device 300A includes a display unit 308 and an operation unit 310. The display unit 308 may be, for example, a liquid crystal display or an electroluminescent panel. The operation unit 310 may be, for example, a keyboard, a pointing device, or the like. More specifically, in the present embodiment, the operation unit 310 includes a touch panel, and is substantially integrated with the display unit 308.

The control unit 304 includes a CPU and a main storage unit, similar to the control unit 204 of the server device 200. The CPU of the control unit 304 executes an application program (hereinafter, “application”) 3061 stored in the storage unit 306. The application 3061 is an application program for accessing information distributed from a web browser or the server device 200. The application 3061 has a GUI, accepts an input by the user (for example, access), and transmits the input to the server device 200 via the network N. The first user can input the P/D request or the boarding request via the user device 300 and transmit the request to the server device 200. For example, the P/D information may include information on the first user's demand to board.

Moreover, in FIGS. 2, 3 and 4, the autonomous vehicle 100, the server device 200 and the user device 300 are connected by the same network N. However, this connection may be implemented by a plurality of networks. For example, a network that connects the autonomous vehicle 100 and the server device 200 and a network that connects the server device 200 and the user device 300 may be different networks.

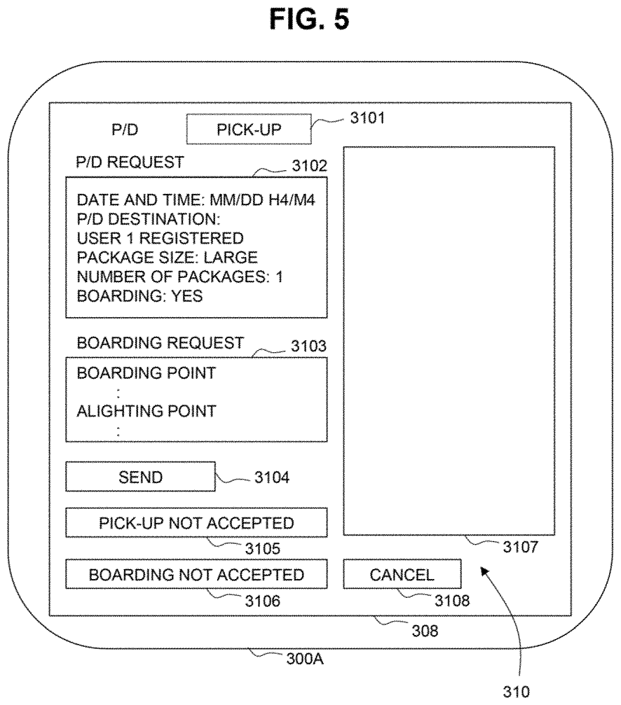

The processing in the P/D system S having the configuration stated above will be described referring to FIGS. 5 to 7. The input of the P/D request in the user device 300 will be described based on FIG. 5. Hereinbelow, a user U is the first user, a terminal device held by the user U is the user device 300A, and the autonomous vehicle 100 used for package P/D for the user U is the autonomous vehicle 100A.

FIG. 5 is one example of a screen of the display unit 308 of the user device 300A when the application 3061 is executed. The display unit 308 also corresponds to the operation unit 310 as a touch panel. The user U wants “pick-up” as the package P/D herein, thus the user U touches a P/D button 3101 on the display unit 308 to select “pick-up” from among “pick-up” and “delivery.” In FIG. 5, “pick-up” is selected. As “pick-up” is selected by the P/D button 3101, the user's demand is input in a P/D request column 3102. The P/D request includes information on a date and time, P/D destination, size and number of packages, and whether or not the user wants to board. When a SEND button 3104 is pressed after “pick-up” is selected and the user's demand is input, information on a “pick-up” request is transmitted to the server device 200 as the P/D request. This information includes the information “user 1 registered”, which is a registration destination of the user U, as the P/D destination, and also includes the user information such as a terminal ID of the user device 300A, that is, a user ID. However, the P/D destination may be a location other than the registration destination of the user U. In this case, a boarding request column 3103 and a route information column 3107 are substantially blank, and both a P/D display 3105 and a boarding display 3106 are still undetermined.

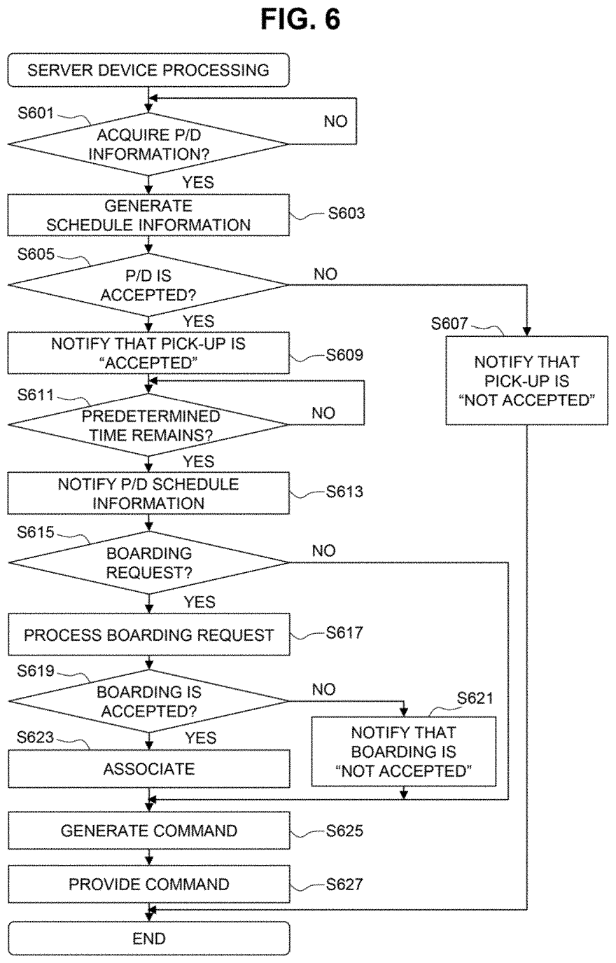

The processing in the server device 200 will be described based on a flowchart in FIG. 6. The information on the P/D request from the user device 300A is acquired by the information acquisition unit 2041 of the server device 200 (YES in step S601). Then, the acquired information is transmitted to the P/D management unit 2043. The schedule generation unit 1a of the P/D management unit 2043 refers to the map information database 2062 of the storage unit 206 based on the information on the P/D destination. The schedule generation unit 1a generates the P/D route based on the information on the P/D request, including the desired P/D date and time, P/D destination, and size and number of packages for P/D. Further, the schedule generation unit 1a generates the schedule information on the scheduled passing time at which the vehicle passes a predetermined number of points (or a predetermined travel distance interval, a predetermined travel time interval, or the like) on the generated P/D route (step S603). FIG. 1 shows a P/D route R as one example where the user device 300A is located at the P/D destination. The P/D route R is generated in accordance with a predetermined program, and is defined herein as a route from the P/D center C to the P/D destination, as shown by a solid line in FIG. 1. There is an ABC station ST that the user U uses daily at a location slightly deviated from the P/D route R, within a predetermined range (hereinafter “first predetermined range”) around the P/D route R. It is determined whether or not the schedule information has been generated, that is, whether or not the P/D can be accepted (step S605). When the schedule information cannot be generated, for example, when an autonomous vehicle suitable for P/D cannot be determined, the P/D cannot be accepted (NO in step S605). Thus a notification that the P/D is “not accepted” is transmitted to the user device 300A (step S607). At this time, the P/D display 3105 on the display unit 308 of the user device 300A changes to a display corresponding to “not accepted.” On the other hand, when the P/D can be accepted (YES in step S605), a notification that the P/D is “accepted” is transmitted to the user device 300A (step S609). At this time, the P/D display 3105 on the display unit 308 of the user device 300A changes to a display corresponding to “accepted.” Moreover, when the notification that the P/D is “not accepted” or “accepted” is transmitted to the user device 300A, the schedule generation unit 1a of the P/D management unit 2043 of the server device 200 transmits, to the information providing unit 2045, information corresponding to such a notification. The information providing unit 2045 refers to the user information database 2063 of the storage unit 206 based on the user information included in such information, acquires contact information of the user device 300A, and transmits such information to the user device 300A.

After the P/D is accepted (after step S609), the schedule generation unit 1a of the P/D management unit 2043 notifies the command generation unit 1b of the P/D management unit 2043 and the boarding/alighting management unit 2044 of the control unit 204 of a processing after the P/D is accepted. The boarding/alighting management unit 2044 determines whether or not a time remaining until a scheduled time of the package P/D becomes a predetermined time (step S611). The scheduled time of the package P/D may be a desired time included in the information on the P/D, transmitted from the user device 300A to the server device 200, but may have a certain margin. Further, the predetermined time can be optionally set, but it is set herein half a day before (12 hours before). When the time remaining until the scheduled time of the package P/D becomes the predetermined time, the positive determination is made (YES in step S611). However, if the remaining time until the scheduled time of the package P/D is shorter than the predetermined time when the P/D is accepted, the positive determination is made that the remaining time until the scheduled time of the package P/D has already been the predetermined time.

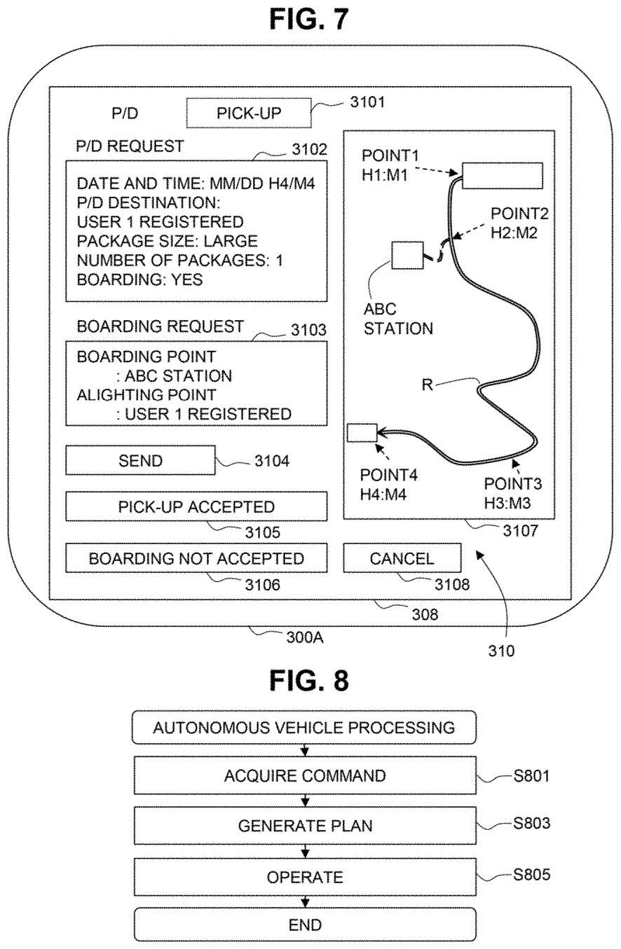

When the time remaining until the scheduled time of the package P/D becomes the predetermined time (YES in step S611), the schedule notification unit 2a of the boarding/alighting management unit 2044 of the control unit 204 transmits the schedule information related to the P/D to the user device 300A (step S613). Thereby, as shown in FIG. 7, the schedule information is displayed on the display unit 308 of the user device 300A. In FIG. 7, the route information column 3107 shows the P/D route R shown in FIG. 1, and the scheduled passing times (H1:M1, H2:M2, H3:M3 and H4:M4) at respective points (Point 1, Point 2, Point 3 and Point 4) on the P/D route R. Moreover, Point 4 shown in FIG. 7 corresponds to a delivery destination, and the time “H4:M4” is the same as the time input in the P/D request column 3102, i.e. the scheduled P/D time.

The user U of the user device 300A shown in FIG. 5 wants to board the vehicle. The user U of the user device 300A shown in FIG. 7 also wants to board the vehicle while the ABC station ST is selected as a boarding point. This boarding point is a first location, which needs to be on the P/D route R or within the first predetermined range around the P/D route R. An alighting point remains “user 1 registered”, which is the P/D destination, since “pick-up” is selected. When the SEND button 3104 is pressed in this state, the information on the boarding request is transmitted to the server device 200.

The request processing unit 2b of the boarding/alighting management unit 2044 of the server device 200 receives the information on the user U's boarding request via the information acquisition unit 2041 (YES in step S615), and performs a predetermined processing on the boarding request (step S617). Examples of the predetermined processing include a process of confirming whether or not the predetermined autonomous vehicle 100A associated with the schedule information has a free space for the user U, and a process of determining whether or not it is possible to temporally, or in relation with another P/D, correct or modify the route such that the user U boards the vehicle at the boarding point. As a result of the predetermined processing, when it is not determined that the user U can board the vehicle, the boarding is not accepted (NO in step S619). Thus a notification that the boarding is “not accepted” is transmitted to the server device 200 (step S621). Consequently, the boarding display 3106 shown in FIG. 7 changes to a display corresponding to “not accepted.” In the present embodiment, when the boarding is not accepted, the processing usually proceeds to the next step as shown in FIG. 6. On the other hand, when the boarding is not accepted, the control unit 204 of the server device 200 may allow the user U to input again by changing the boarding conditions of the boarding request. At this time, the determination in step S615 may be performed again.

On the other hand, when the boarding is accepted (YES in step S619), the association unit 2c of the boarding/alighting management unit 2044 of the control unit 204 of the server device 200 transmits the boarding information of the user U to the command generation unit 1b, and associates it with the schedule information generated by the schedule generation unit 1a (step S623). Accordingly, based on the schedule information associated with the boarding information, the command generation unit 1b of the P/D management unit 2043 generates information on the service command (step S625). The information providing unit 2045 of the control unit 204 provides, i.e. transmits, the information on the service command to the autonomous vehicle 100A (step S627). The transmission of the information on the service command corresponds to the transmission of the command for transporting the user U from the ABC station (first location) to the P/D destination, to the autonomous vehicle 100A, which is the moving vehicle for P/D. The schedule information is based on the P/D request, and the information on the service command includes the P/D information, and boarding information associated therewith.

Although the schedule information is notified to the user device 300A (step S613), when the information on the boarding request cannot be received within the predetermined time (NO in step S615), the service command including the P/D information is generated based only on the schedule information (step S625). Furthermore, when the boarding request is made (YES in step S615) but the boarding is not accepted (NO in step S619), the service command including the P/D information is generated based on only the schedule information (step S625). In such a case, since the user U cannot board the vehicle, the user U may be absent at the P/D destination at the scheduled P/D time. Therefore, in such a case, the user U also can cancel the P/D by pressing a cancel button 3108 of the user device 300A. However, in the present embodiment, a pick-up request includes a user's “demand” to board the vehicle, as shown in FIGS. 5 and 7, and the server device 200 never denies the boarding due to no free space for the user U in the autonomous vehicle 100A.

A processing of the autonomous vehicle 100A that has received the service command will be described referring to a flowchart of FIG. 8. The information acquisition unit 1041 of the control unit 104 of the autonomous vehicle 100A acquires the information on the service command from the server device 200 (step S801). The plan generation unit 1042 of the control unit 104 generates a service plan based on the pick-up information, that is, the schedule information and the boarding information on the service command (step S803). The plan generation unit 1042 basically generates the service plan based on the schedule information and the boarding information, but also in consideration of road conditions on the day, for example traffic restriction information. Considering the scheduled passing time, the task control unit 1044 of the control unit 104 of the autonomous vehicle 100A operates based on the service plan (step S805). By this operation, the autonomous vehicle 100A transports the user U (first user) to the P/D destination. The autonomous vehicle 100A can pick up the package from the user U at the P/D destination.

Although a case of picking up the package has been described as an example, the same applies to a case of delivering the package. In a case of delivering the package, the user U is a user who receives the package. Also at this time, the user U boards the vehicle while the autonomous vehicle 100A travels to the P/D destination, and the autonomous vehicle 100A transports the user U to the P/D destination.

Further, since the user U is a user related to the package P/D, the user U may board the vehicle only by paying a delivery charge for the package. However, a boarding charge may be collected from the user U when the user U boards the vehicle.

As described above, in the P/D system S, the control unit 204 of the server device 200 (information processing apparatus) receives the P/D request from the user U, generates the schedule information including the P/D route, and notifies the user device 300A held by the user U of such information. When the user U requests the boarding, the control unit 204 of the server device 200 accepts the request and transmits, to the autonomous vehicle 100A, the command of P/D together with the command for transporting the user U to the P/D destination. Therefore, it is possible to enhance the convenience of the user U, who requests the service, during use of the package P/D service. Accordingly, it is possible to prevent a problem from occurring wherein the user U is absent at the P/D destination at the scheduled P/D time, and it is possible to improve the efficiency of P/D of the P/D system S.

Next, a second embodiment of the present disclosure will be described. Hereinafter, differences between a P/D system according to the second embodiment and the P/D system S according to the first embodiment will be mainly described. Components corresponding to the components already described are similarly denoted by the same reference numerals, and the same descriptions are omitted.

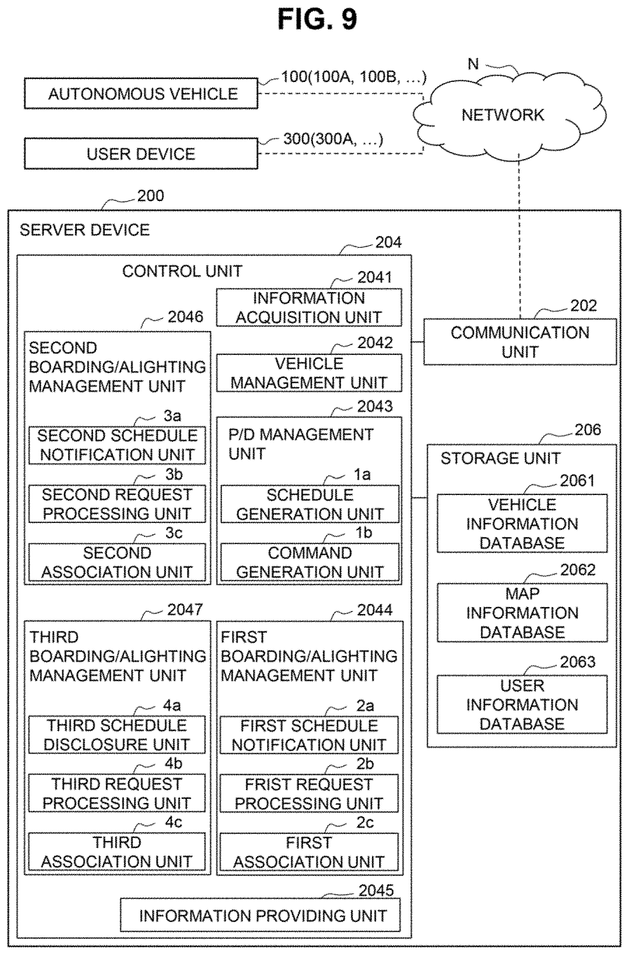

In the P/D system S according to the first embodiment, the user U related to the P/D boards the vehicle while the vehicle travels to the P/D destination, and the vehicle transports the user to the P/D destination. Further, in the second embodiment, the P/D route is notified or disclosed to a user who is not particularly involved in the P/D, and when such a user wants to board, he/she can board the moving vehicle related to the P/D even if he/she is unrelated to the P/D. Hereinafter, a boarding process for the user who is not particularly involved in the P/D will be described referring to FIGS. 9 to 12. Moreover, the following boarding process for the user not particularly involved in the P/D is combined with the boarding process for the user U related to the P/D in the first embodiment.

A configuration of the server device 200 in the P/D system according to the second embodiment will be described referring to FIG. 9. The server device 200 (information processing apparatus) differs from the server device 200 of the first embodiment in terms of a configuration of the control unit 204. As illustrated in FIG. 9, the control unit 204 includes, as functional modules, the information acquisition unit 2041, the vehicle management unit 2042, the P/D management unit 2043, the boarding/alighting management unit 2044, and the information providing unit 2045, as well as a second boarding/alighting management unit 2046 and a third boarding/alighting management unit 2047. Further, the second boarding/alighting management unit 2046 has a second schedule notification unit 3a, a second request processing unit 3b, and a second association unit 3c. Further, the third boarding/alighting management unit 2047 has a third schedule disclosure unit 4a, a third request processing unit 4b, and a third association unit 4c. Each of these functional modules is implemented by executing a program stored in the main storage unit or the storage unit 206 by the CPU of the control unit 204.

Also in the second embodiment, as described in the first embodiment, the control unit of the server device 200 notifies the user device 300A, held by the user U related to the P/D, of the schedule information including the P/D route R and the scheduled passing time of such a route, and when the user wants to board the vehicle, accepts the boarding request that the user wants to board from the P/D route R or the first location within the first predetermined range around the P/D route R to the P/D destination, and transmits to the autonomous vehicle 100A the command for transporting the user U from the first location to the P/D destination upon the P/D. The boarding of the user U is managed by the boarding/alighting management unit 2044 of the control unit 204. Hereinafter, the boarding/alighting management unit 2044 is called a first boarding/alighting management unit as being distinctive from the second boarding/alighting management unit 2046 and the third boarding/alighting management unit 2047. Moreover, the schedule notification unit 2a, the request processing unit 2b and the association unit 2c, of the first boarding/alighting management unit 2044, are referred to as a first schedule notification unit, a first request processing unit, and a first association unit, respectively. The same will be applied to FIG. 9.

The second boarding/alighting management unit 2046 manages boarding and alighting of users other than the user U, who is the first user and related to the P/D. In particular, the second boarding/alighting management unit 2046 manages a user X having a registration destination within a predetermined range around the P/D destination (hereinafter “second predetermined range”), and who may board and alight the autonomous vehicle 100A related to the P/D. Moreover, the user X may be one or more people. The user information database 2063 of the storage unit 206 includes not only user IDs of the users, but also desired destination of boarding/alighting, registered by each user. The second schedule notification unit 3a extracts a user having the registration destination within the second predetermined range around the P/D destination as the user X, and notifies the user device 300 (terminal of the user X) of the P/D route and the scheduled passing time of such a route. Moreover, the user X corresponds to a second user. The second request processing unit 3b receives the boarding request that the user X wants to board the vehicle at a location (hereinafter “second location”) on the P/D route or within a predetermined range (hereinafter “third predetermined range”) around the P/D route, from the user device 300 held by the user X, and executes a predetermined processing as in a case of the user U. When the boarding of the user X can be accepted, the second association unit 3c transmits the boarding information of the user X to the command generation unit 1b of the P/D management unit 2043, and associates it with the schedule information generated by the schedule generation unit 1a. Consequently, the service command including the boarding information of the user X is generated and transmitted to the autonomous vehicle 100A.

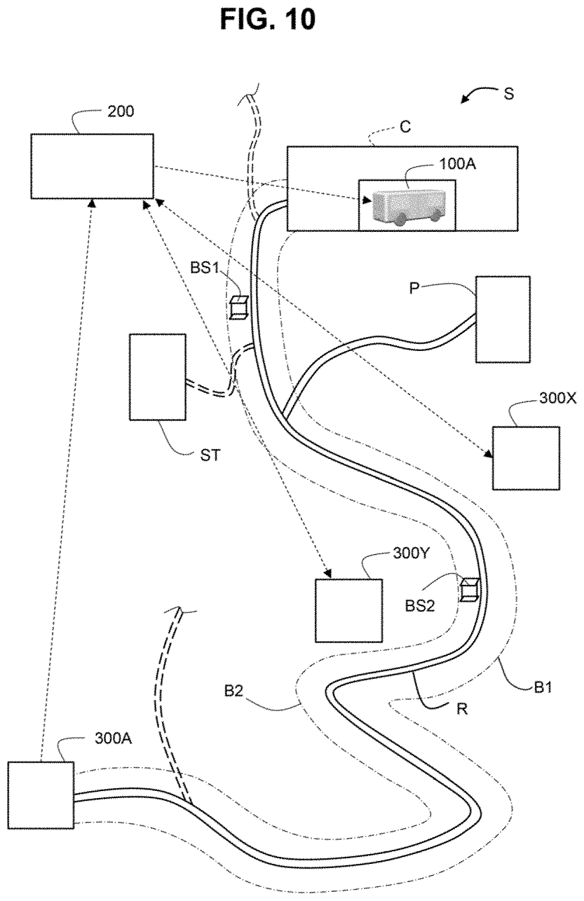

The second predetermined range of the P/D destination that may include the registration destination of the user X may be an area (for example, an administrative section) including the P/D destination. Alternatively, the second predetermined range may be a range within a predetermined distance from the P/D destination. The third predetermined range including the second location is preferably a range that is not greatly deviated from the P/D route R, which is herein a range extended along the P/D route R and sandwiched between boundaries B1 and B2 within a predetermined distance therefrom, as shown in FIG. 10. The second location may be limited to within the P/D route R. This is because it is preferable that the user X boards, and preferably also alights, the vehicle, without impairing the efficiency of the P/D for the user U. FIG. 10 illustrates a user device 300X as the user device 300 as the terminal of the user X.

The third boarding/alighting management unit 2047 manages boarding and alighting of users other than the user U, who is the first user and related to the P/D, similar to the second boarding/alighting management unit 2046. However, different from the second boarding/alighting management unit 2046, the third boarding/alighting management unit 2047 discloses the schedule information on a predetermined website, receives a user's boarding request from the predetermined website, and manages the boarding and alighting of such a user. The third schedule disclosure unit 4a discloses the P/D route R and the scheduled passing time on the predetermined website of such a route. The third request processing unit 4b receives the boarding request that a user Y wants to board the vehicle at a location (hereinafter “fourth location”) on the P/D route R or within a predetermined range (hereinafter “fourth predetermined range”) around the P/D route R, from the user Y who accesses the predetermined website, and executes the predetermined processing as stated above. Moreover, the user Y corresponds to a third user. When the boarding of the user Y can be accepted, the third association unit 4c transmits the boarding information of the user U to the command generation unit 1b of the P/D management unit 2043, and associates it with the schedule information generated by the schedule generation unit 1a. Consequently, the service command including the boarding information of the user Y is generated and transmitted to the autonomous vehicle 100A.

The fourth predetermined range including the fourth location is preferably a range that is not greatly deviated from the P/D route R, similar to the third predetermined range, which is herein a range sandwiched between the boundaries B1 and B2. The fourth predetermined range may be different from the third predetermined range. The fourth location may be limited to within the P/D route R. This is because it is preferable that the user Y boards, and preferably also alights, the vehicle, without impairing the efficiency of the P/D for the user U. FIG. 10 illustrates a user device 300Y as the terminal of the user Y who accesses the predetermined website.

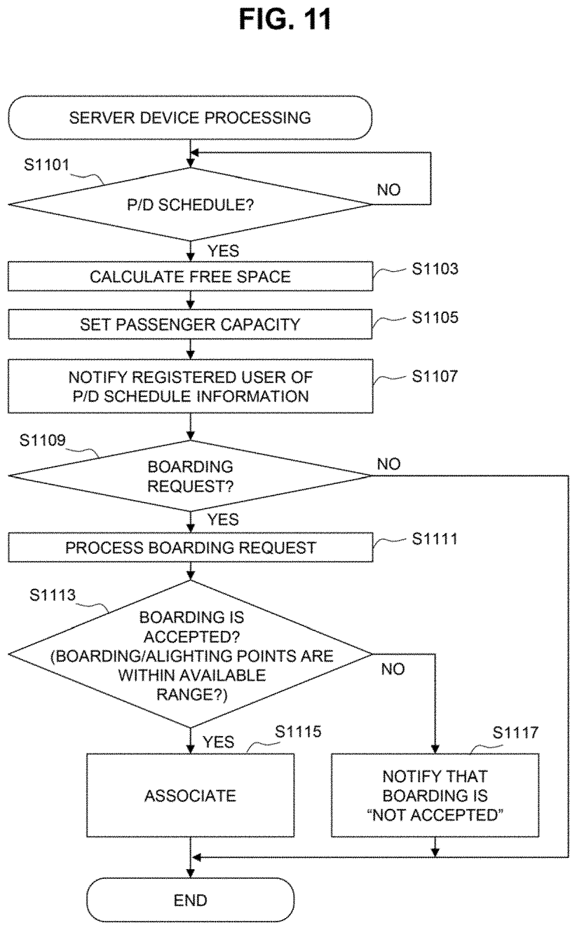

The processing by the second boarding/alighting management unit 2046 of the control unit 204 of the server device 200 will be described referring to a flowchart of FIG. 11. Upon the package P/D for the user U, when the time remaining until the scheduled time of the package P/D becomes the predetermined time (YES in step S611 of FIG. 6), the schedule notification unit 2a of the first boarding/alighting management unit 2044 of the control unit 204 transmits the schedule information related to the P/D to the user device 300A held by the user U (step S613). Cooperating with this, the second schedule notification unit 3a of the second boarding/alighting management unit 2046 receives the P/D schedule of the user U (YES in step S1101), and calculates an amount of free space in the autonomous vehicle 100A. Further, the second schedule notification unit 3a calculates the amount of free space in the autonomous vehicle 100A based on a loading status of the autonomous vehicle 100A before and after its P/D, package size, and the like (step S1103). Then, the number of people who can board the autonomous vehicle 100A is set in accordance with the free space (step S1105). Accordingly, the schedule notification unit 3a notifies the user device 300X of the user X (registered user) of the passenger capacity, as well as the schedule information including the P/D route R and the scheduled passing time of such a route (step S1107). The passenger capacity notified at this time is preferably a number obtained by subtracting the user U related to the P/D, and it is preferably a number at least one less than the calculated passenger capacity. The passenger capacity notified to the user device 300X of the user X can be the number of people who can board other than the user U.

Consequently, the passenger capacity is displayed on the user device 300X of the user X, as well as the items on the screen shown in FIG. 5. The user X can predict a crowded status of the autonomous vehicle 100A by referring to the passenger capacity. Then, when the user X requests the boarding from the user device 300X (YES in step S1109), the second request processing unit 3b executes a predetermined processing of the boarding request (step S1111). When the boarding point (that is, the second location) for the boarding request of the user X is within the third predetermined range, that is, the range sandwiched between the boundaries B1 and B2, for example, a bus stop BS2 among two bus stops BS1 and BS2 along the P/D route R shown in FIG. 10, boarding conditions of the boarding request are satisfied. In addition, the alighting point (that is, the third location) of the boarding conditions of the user X is also within the third predetermined range, that is, the range sandwiched between the boundaries B1 and B2. For example, the user X can set the P/D destination as the alighting point. At this time, since the boarding and alighting locations are within the available range, the boarding is accepted (YES in step S1113), the second association unit 3c of the second boarding/alighting management unit 2046 of the control unit 204 of the server device 200 transmits the boarding information of the user X to the command generation unit 1b, and associates the information with the schedule information generated by the schedule generation unit 1a (step S1115). Accordingly, based on the schedule information associated with the boarding information, the command generation unit 1b of the P/D management unit 2043 generates information on the service command (step S625). The information providing unit 2045 of the control unit 204 provides, i.e. transmits, the information on the service command to the autonomous vehicle 100A (step S627). The transmission of the information on the service command corresponds to the transmission of the command for transporting the second user from the second location to the third location on the way to the P/D destination, to the autonomous vehicle 100A.

On the other hand, for example, when the boarding or alighting point of the boarding request of the user X is a park P (see FIG. 10) outside the boundaries B1 and B2, the conditions of the boarding request are not satisfied. In this case, the boarding is not accepted (NO in step S1113), and a notification that the boarding is “not accepted” is transmitted to the user device 300X of the user X (step S1117). Further, at this time, the user device 300X may be allowed to input the boarding request again.

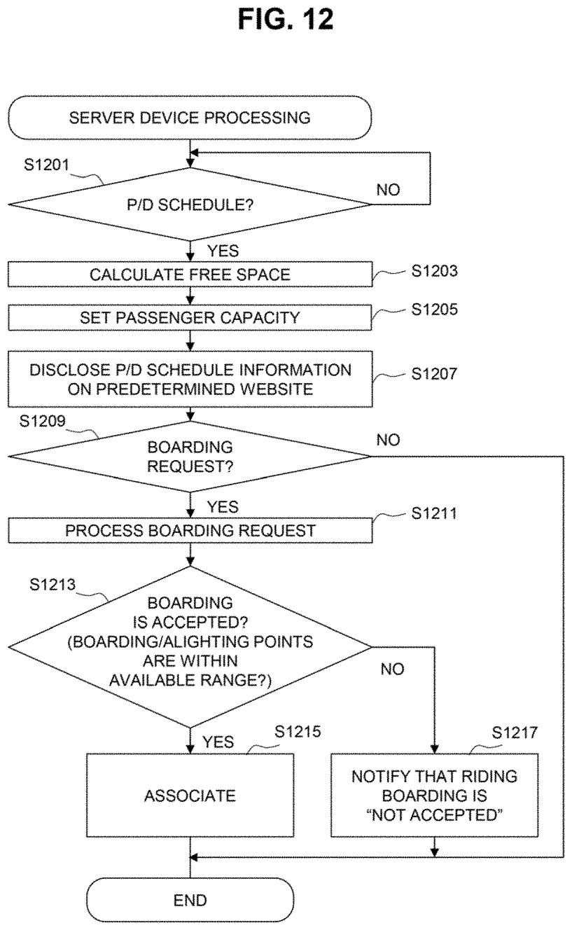

The processing by the third boarding/alighting management unit 2047 of the control unit 204 of the server device 200 will be described referring to a flowchart of FIG. 12. Upon the package P/D for the user U, when the time remaining until the scheduled time of the package P/D becomes the predetermined time (YES in step S611 of FIG. 6), the first schedule notification unit 2a of the first boarding/alighting management unit 2044 of the control unit 204 transmits the schedule information related to the P/D to the user device 300A (step S613). Cooperating with this, the third schedule disclosure unit 4a of the third boarding/alighting management unit 2047 receives the P/D schedule of the user U (YES in step S1201), and calculates an amount of free space of the autonomous vehicle 100A. Further, the third schedule disclosure unit 4a calculates the amount of free space of the autonomous vehicle 100A based on a loading status of the autonomous vehicle 100A before and after its P/D, package size, and the like (step S1203). The calculation of the amount of free space may include reading the value calculated in step S1103. Then, the number of people who can board the autonomous vehicle 100A is set in accordance with the free space (step S1205). Accordingly, the third schedule disclosure unit 4a discloses the passenger capacity, as well as the schedule information including the P/D route R and the scheduled passing time of such a route, on the predetermined website (step S1207). The passenger capacity disclosed at this time is preferably a number obtained by subtracting the user U related to the P/D, and it is preferably a number at least one less than the calculated passenger capacity.

Then, when the user Y accesses the predetermined website from the user device 300Y and inputs the boarding request (YES in step S1209), the third request processing unit 4b executes a predetermined processing of the boarding request (step S1211). When the boarding point (that is, the fourth location) for the boarding request of the user Y is within the fourth predetermined range, that is, the range sandwiched between the boundaries B1 and B2, boarding conditions of the boarding request are satisfied. In addition, the alighting point (that is, the fifth location) of the boarding conditions of the user Y is also within the fourth predetermined range, that is, the range sandwiched between the boundaries B1 and B2. For example, the user Y can set the P/D destination as the alighting point. At this time, since the boarding and alighting locations are within the available range, the boarding is accepted (YES in step S1213), the third association unit 4c of the second boarding/alighting management unit 2046 of the control unit 204 of the server device 200 transmits the boarding information of the user Y to the command generation unit 1b, and associates it with the schedule information generated by the schedule generation unit 1a (step S1215). Accordingly, based on the schedule information associated with the boarding information, the command generation unit 1b of the P/D management unit 2043 generates information on the service command (step S625). The information providing unit 2045 of the control unit 204 provides, i.e. transmits, the information on the service command to the autonomous vehicle 100A (step S627). The transmission of the information on the service command corresponds to the transmission of the command for transporting the third user from the fourth location to the fifth location on a way to the P/D destination, to the autonomous vehicle 100A.

On the other hand, for example, when the boarding or alighting point of the boarding request of the user Y is outside the boundaries B1 and B2, the conditions of the boarding request are not satisfied. At this time, the boarding is not accepted (NO in step S1213), and a notification that the boarding is “not accepted” is transmitted to the user device 300Y of the user Y (step S1217). Further, at this time, the predetermined website accessed by the user device 300Y allows the user to input the boarding request again.

As described above, in the second embodiment, the users X and Y other than the user U related to the P/D can also be transported to a location that is on the way to the P/D destination as they board the autonomous vehicle 100A upon the P/D. Therefore, it is possible to enhance the convenience of a third party other than the customer (for example, the user U) of the P/D service while providing such a service.

In the embodiment stated above, the user X and the user Y, as well as the user U related to the P/D, can board the autonomous vehicle 100A which is the moving vehicle related to the P/D. However, only one of the user X and the user Y may be allowed to board with the user U. The locations, where the users X and Y board and alight, can be located only on the P/D route, as described above, with the highest priority given to the P/D of the user U. In this way, the efficiency of the P/D can be further improved, and the convenience of the user of the P/D service, that is, the user U, can be further enhanced.

Since the users X and Y are not involved in the package P/D, it is preferable that those users be charged. In this case, a boarding charge may be a fixed amount or may vary depending on a distance traveled.

The embodiments stated above are mere examples, and the present disclosure can be implemented with appropriate modifications within a scope not departing from the gist thereof. The processing and units described in the present disclosure can be freely combined and implemented unless technical contradiction occurs.

Further, the processing described as being performed by a single device may be executed in a shared manner by a plurality of devices. For example, the server device 200 (information processing apparatus) and the information processing apparatus 102 of the autonomous vehicle 100 need not be a single computer, and may be configured as a system including several computers. Alternatively, the processing described as being performed by different devices may be executed by a single device. In the computer system, the hardware configuration (server configuration) for implementing each function can be flexibly changed.

The present disclosure can also be implemented by supplying a computer program for executing the functions described in the embodiments in a computer, and reading and executing the program by one or more processors included in the computer. Such a computer program may be provided to the computer by a non-transitory computer-readable storage medium connectable to a computer system bus, or may be provided to the computer via the network. Examples of the non-transitory computer-readable storage media include random disk (such as a magnetic disk (floppy (registered trademark) disk, hard disk drive (HDD), and the like) or optical disk (CD-ROM, DVD disk, Blu-ray disk, and the like)), read-only memory (ROM), random access memory (RAM), EPROM, EEPROM, magnetic card, flash memory, optical card, and random type of medium suitable for storing electronic instructions.

What is claimed is:

1. An information processing apparatus comprising:
a control unit configured to execute:
notifying a terminal held by a first user associated with pick-up and delivery of a package of a pick-up and delivery route and a scheduled passing time of the pick-up and delivery route, at a predetermined time before a scheduled pick-up and delivery time;
receiving a boarding request of the first user from the terminal, the boarding request for boarding at a first location on the pick-up and delivery route or within a first predetermined range around the pick-up and delivery route; and
transmitting, to a moving object traveling for the pick-up and delivery, a command for transporting the first user from the first location to a pick-up and delivery destination.

2. The information processing apparatus according to claim 1, wherein:
the control unit is configured to receive a pick-up and delivery request for the package; and
the pick-up and delivery request includes information on the first user's demand to board.

3. The information processing apparatus according to claim 1, wherein the control unit is configured to further execute:
notifying a terminal held by a second user, having a registration destination within a second predetermined range around the pick-up and delivery destination, of the pick-up and delivery route and the scheduled passing time of the pick-up and delivery route;
receiving a boarding request of the second user from the terminal held by the second user, the boarding request for boarding at a second location on the pick-up and delivery route or within a third predetermined range around the pick-up and delivery route;
transmitting, to the moving object, a command for transporting the second user from the second location to a third location on a way to the pick-up and delivery destination.

4. The information processing apparatus according to claim 3, wherein:
the boarding request at the second location includes information on the third location; and
the control unit is configured to receive the boarding request from the second user when the third location is on the pick-up and delivery route or within the third predetermined range around the pick-up and delivery route.

5. The information processing apparatus according to claim 3, wherein:
the control unit is configured to further execute setting a passenger capacity according to a free space within the moving object; and
notifying the terminal held by the second user includes notifying regarding an amount of people other than the first user that are allowed to board the moving vehicle.

6. The information processing apparatus according to claim 1, wherein the control unit is configured to further execute:
disclosing the pick-up and delivery route and the scheduled passing time of the pick-up and delivery route to a predetermined website;
receiving, from the predetermined website, a third user's boarding request for boarding at a fourth location on the pick-up and delivery route or within a fourth predetermined range around the pick-up and delivery route; and
transmitting, to the moving object, a command for transporting the third user from the fourth location to a fifth location on the way to the pick-up and delivery destination.

7. The information processing apparatus according to claim 6, wherein:
the boarding request at the fourth location includes information on the fifth location; and
the control unit is configured to receive the boarding request from the third user when the fifth location is on the pick-up and delivery route or within the fourth predetermined range around the pick-up and delivery route.

8. The information processing apparatus according to claim 6, wherein:
the control unit is configured to further execute setting a passenger capacity according to the free space of the moving object; and
disclosing to the predetermined website includes disclosing regarding an amount of people other than the first user that are allowed to board the moving vehicle.

9. An information processing method executed by at least one computer, comprising:
notifying a terminal held by a first user associated with pick-up and delivery of a package of a pick-up and delivery route and a scheduled passing time of the pick-up and delivery route, at a predetermined time before a scheduled pick-up and delivery time;
receiving a boarding request of the first user from the terminal, the boarding request for boarding at a first location on the pick-up and delivery route or within a first predetermined range around the pick-up and delivery route; and
transmitting, to a moving object traveling for the pick-up and delivery, a command for transporting the first user from the first location to a pick-up and delivery destination.

10. The information processing method according to claim 9, wherein:
the at least one computer receives a pick-up and delivery request of the package; and
the pick-up and delivery request includes information on the first user's demand to board.

11. The information processing method according to claim 9, wherein the at least one computer further executes:
notifying a terminal held by a second user, having a registration destination within a second predetermined range around the pick-up and delivery destination, of the pick-up and delivery route and the scheduled passing time of the pick-up and delivery route;
receiving a boarding request of the second user from the terminal held by the second user, the boarding request for boarding at a second location on the pick-up and delivery route or within a third predetermined range around the pick-up and delivery route;
transmitting, to the moving object, a command for transporting the second user from the second location to a third location on a way to the pick-up and delivery destination.

12. The information processing method according to claim 11, wherein:
the boarding request at the second location includes information on the third location; and
the at least one computer receives the boarding request from the second user when the third location is on the P/D route or within the third predetermined range around the pick-up and delivery route.

13. The information processing method according to claim 11, wherein:
the at least one computer further executes setting a passenger capacity according to an amount of free space of the moving object, and
notifying the terminal held by the second user including notifying regarding an amount of people other than the first user that are allowed to board the moving vehicle.

14. The information processing method according to claim 9, wherein the at least one computer further executes:
disclosing the pick-up and delivery route and the scheduled passing time of the pick-up and delivery route to a predetermined website;
receiving from the predetermined website a third user's boarding request for boarding at a fourth location on the pick-up and delivery route or within a fourth predetermined range around the pick-up and delivery route; and
transmitting, to the moving object, a command for transporting the third user from the fourth location to a fifth location on the way to the pick-up and delivery destination.

15. The information processing method according to claim 14, wherein:
the boarding request at the fourth location includes information on the fifth location; and
the at least one computer receives the boarding request from the third user when the fifth location is on the pick-up and delivery route or within the fourth predetermined range around the pick-up and delivery route.

16. The information processing method according to claim 14, wherein:
the at least one computer further executes setting a passenger capacity according to a free space of the moving vehicle, and
disclosing to the predetermined website includes disclosing regarding an amount of people other than the first user that are allowed to board the moving vehicle.

17. A program causing at least one computer to execute:
notifying a terminal held by a first user associated with pick-up/delivery of a package of a pick-up and delivery route and a scheduled passing time of the pick-up and delivery route, at a predetermined time before a scheduled pick-up and delivery time;
receiving a boarding request of the first user from the terminal, the boarding request for boarding at a first location on the pick-up and delivery route or within a first predetermined range around the pick-up and delivery route;
transmitting, to a moving object traveling for the pick-up and delivery, a command for transporting the first user from the first location to a pick-up and delivery destination.
